(19) United States
(12) Patent Application Publication
(10) Pub. No.: US 2014/0334207 A1
(43) Pub. Date: Nov. 13, 2014

(54) CONTROLLING AN ELECTRICAL CONVERTER

(71) Applicant: ABB Research Ltd, Zürich (CH)

(72) Inventors: Helfried PEYRL, Zürich (CH); Stefan RICHTER, Fislisback (CH)

(73) Assignee: ABB RESEARCH LTD, Zürich (CH)

(21) Appl. No.: 14/339,223

(22) Filed: Jul. 23, 2014

Related U.S. Application Data
(63) Continuation of application No. PCT/EP2013/050733, filed on Jan. 16, 2013.

(30) Foreign Application Priority Data
Jan. 24, 2012 (EP) 12152208.0

(51) Int. Cl. H02M 7/48

(52) U.S. Cl. CPC H02M 7/48
USPC 363/123

(57) ABSTRACT

A method, a computer-readable medium for controlling an electrical converter, and a controller are disclosed. The method for controlling an electrical converter can include receiving an actual switching state uₖ₋₁ of the electrical converter; determining a scenario tree for future switching states of the electrical converter based on the actual switching state uₖ₋₁, the scenario tree defining a plurality of future switching sequences, a switching sequence U being defined by a path from a root node of the scenario tree to a leave node of the scenario tree; calculating a weight w for a switching sequence by evaluating nodes of the scenario tree; and determining the next switching state uₖ to be applied to the electrical converter from a switching sequence with a best weight. The evaluation of the nodes can be performed by at least two processor cores.

### RELATED APPLICATION(S)

This application claims priority as a continuation application under 35 U.S.C. §120 to PCT/EP2013/050733, which was filed as an International Application on Jan. 16, 2013, designating the U.S., and which claims priority to European Application 12152208.0 filed in Europe on Jan. 24, 2012. The entire contents of these applications are hereby incorporated by reference in their entireties.

### FIELD

The disclosure relates to a method, a computer program and a computer-readable medium for controlling an electrical converter as well as to a controller of an electrical converter and a converter system.

### BACKGROUND INFORMATION

Direct Torque Control (DTC) is a method for controlling torque and flux of an electrical motor in medium voltage drive applications. One of the drawbacks of DTC can be the fact that the average switching frequency of a converter cannot be directly controlled. Because the switching frequency can be proportionally related to the switching losses of the converter, a major part of the overall losses of the drive, any reduction of the switching frequency can have a significant impact on the operational cost of the drive and increase the overall system robustness and reliability.

Such a reduction has been shown through the Model Predictive Direct Torque Control (MPDTC) method, which can include two model-based optimal control algorithms. The computational complexity of MPDTC uses an FPGA-based implementation and substantial engineering work to meet the needed sampling times.

The MPDTC algorithm has been extended to “Generalized Model Predictive Direct Torque Control” (GMPDTC) (see for example, EP 2 348 631 A1). As with MPDTC, the computational complexity of GMPDTC can increase exponentially with the length of the control horizon making only short horizons tractable.

GMPDTC can be seen as a specialized model predictive control (MPC) algorithm for the torque control of induction machines. The control aim can be to keep machine torque, flux and the neutral point potential of the converter within specified bands while at the same time, the converter switching frequency and power losses can be minimized. Instead of using modulation-based techniques such as PWM, the method can directly manipulate the switching transitions of the converter.

### SUMMARY

A method is disclosed for controlling an electrical converter, the method comprising: receiving an actual switching state (uₖ₋₁) of the electrical converter; determining a scenario tree for future switching states of the electrical converter based on the actual switching state (uₖ₋₁), the scenario tree defining a plurality of future switching sequences, a switching sequence (U) being defined by a path from a root node of the scenario tree to a leave node of the scenario tree; calculating a weight (w) for a switching sequence with respect to a control objective of the electrical converter by evaluating nodes of the scenario tree; determining the next switching state (uₖ) to be applied to the electrical converter from a switching sequence with a best weight; performing the evaluation of the nodes by at least two processor cores; and determining the scenario tree by loading at least parts of the scenario tree from a pre-calculated table, wherein a calculation time of a sub-tree of the scenario tree is predefined in the table.

A method is disclosed for controlling an electrical converter, the method comprising: receiving an actual switching state (uₖ₋₁) of the electrical converter; determining a scenario tree for future switching states of the electrical converter based on the actual switching state (uₖ₋₁), the scenario tree defining a plurality of future switching sequences, a switching sequence (U) being defined by a path from a root node of the scenario tree to a leave node of the scenario tree; calculating a weight (w) for a switching sequence with respect to a control objective of the electrical converter by evaluating nodes of the scenario tree; determining the next switching state (uₖ) to be applied to the electrical converter from a switching sequence with a best weight; performing the evaluation of the nodes by at least two processor cores; and determining the scenario tree by loading at least parts of the scenario tree from a pre-calculated table, wherein a calculation time of a sub-tree of the scenario tree is predefined in the table.

A non-transitory computer readable medium is disclosed having a computer program recorded thereon that, when executed by at least two processor cores, causes the at least two processor cores to carry out a method for controlling an electrical converter, the method comprising: receiving an actual switching state (uₖ₋₁) of the electrical converter; determining a scenario tree for future switching states of the electrical converter based on the actual switching state (uₖ₋₁), the scenario tree defining a plurality of future switching sequences, a switching sequence (U) being defined by a path from a root node of the scenario tree to a leave node of the scenario tree; calculating a weight (w) for a switching sequence with respect to a control objective of the electrical converter by evaluating nodes of the scenario tree; determining the next switching state (uₖ) to be applied to the electrical converter from a switching sequence with a best weight; performing the evaluation of the nodes by the at least two processor cores; and determining the scenario tree by loading at least parts of the scenario tree from a pre-calculated table, wherein a calculation time of a sub-tree of the scenario tree is predefined in the table.

A controller for an electrical converter is disclosed, the controller comprising: a multi-core processor including at least two processor cores; and wherein the multi-core processor is configured to: receive an actual switching state (uₖ₋₁) of an electrical converter; determine a scenario tree for future switching states of an electrical converter based on the actual switching state (uₖ₋₁), the scenario tree defining a plurality of future switching sequences, a switching sequence (U) being defined by a path from a root node of the scenario tree to a leave node of the scenario tree; calculate a weight (w) for a switching sequence with respect to a control objective of an electrical converter by evaluating nodes of the scenario tree; determine the next switching state (uₖ) to be applied to an electrical converter from a switching sequence with a best weight; perform the evaluation of the nodes by the at least two processor cores; and determine the scenario tree by loading at least parts of the scenario tree from a pre-calculated table, wherein a calculation time of a sub-tree of the scenario tree is predefined in the table.

### BRIEF DESCRIPTION OF THE DRAWINGS

The subject matter of the disclosure will be explained in more detail in the following text with reference to exemplary embodiments which can be illustrated in the attached drawings, in which:

FIG. 1 schematically shows an exemplary converter system according to an embodiment of the disclosure;

FIG. 2 shows a flow diagram for method for controlling an exemplary converter according to an embodiment of the disclosure; and

FIG. 3 shows a scenario tree according to an exemplary embodiment of the disclosure.

### DETAILED DESCRIPTION

In accordance with an exemplary embodiment, the disclosure relates to features to accelerate the execution of GMPDTC algorithms.

According to an exemplary embodiment of the disclosure, the method can include the steps of: receiving an actual switching state of the electrical converter; determining a scenario tree for possible future switching states of the electrical converter based on the actual switching state, the scenario tree defining a plurality of possible future switching sequences, a switching sequence being defined by a path from a root node of the scenario tree to a leave node of the scenario tree; calculating a weight and/or cost for a switching sequence by evaluating nodes of the scenario tree; and determining the next switching state to be applied to the electrical converter from a switching sequence with a best weight and/or best cost.

In accordance with an exemplary embodiment, the method can be a GMPDTC method.

In accordance with an exemplary embodiment, the weight and/or cost can be calculated with respect to a control objective of the electrical converter. For example, the weight and/or cost can be calculated with respect to expected switching losses of the switching sequence.

According to an exemplary embodiment of the disclosure, the evaluation of the nodes can be performed by at least two processor cores.

By distributing the evaluation of the nodes of the scenario tree to at least two different processor cores, GMPDTC can be parallelized and thus can be adapted to multi-core processor platforms. Using the additional computational power offered by these platforms can allow solving problems with larger control horizons and therefore can result in improved application performance, for example with further reduced switching losses.

Furthermore, GMPDTC to be executed by a multi-core processor can avoid the need of custom hardware implementations (such as FPGA-based solutions) and therefore can reduce development time and cost.

The disclosure also relates to a computer program for controlling an converter, which, when being executed by at least two processor cores, is adapted (i.e., configured) to carry out the steps of the method as described herein, and a computer-readable medium, in which such a computer program is stored. A computer-readable medium can be a floppy disk, a hard disk, an USB (Universal Serial Bus) storage device, a RAM (Random Access Memory), a ROM (Read Only memory) and an EPROM (Erasable Programmable Read Only Memory).

In accordance with an exemplary embodiment, the disclosure relates to a controller for an electrical converter.

According to an exemplary embodiment of the disclosure, the controller can include a multi-core processor including at least two processor cores. The multi-core processor can be adapted for executing the method as disclosed in the above and in the following. For example, the controller can include further a memory in which the above mentioned computer program is stored.

In accordance with an exemplary embodiment, the disclosure relates to a converter system, for example, a medium voltage drive system.

According to an exemplary embodiment of the disclosure, the converter system can include a converter for generating a variable AC output current and a controller as described in the above and in the following for switching semiconductor switches of the converter.

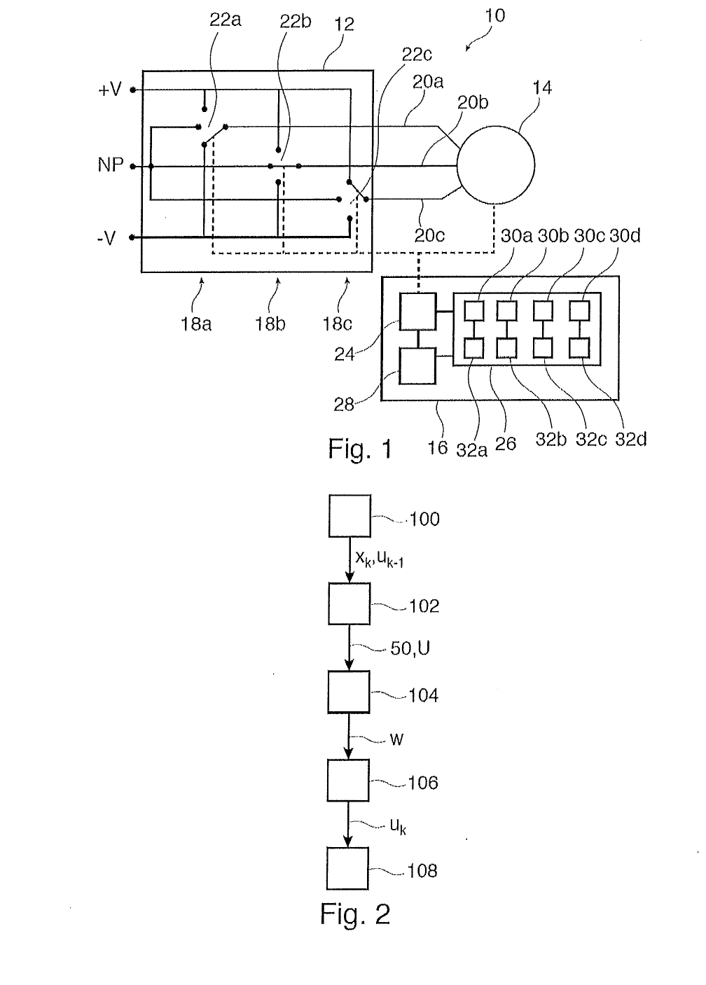

FIG. 1 shows a converter system 10 including a converter 12, an electrical load 14 and a controller 16.

The converter 12 can include three half bridges 18a, 18b, 18c adapted for generating a three level output voltage at the respective phase 20a, 20b, 20c of the load 14 by connecting the respective phase 20a, 20b, 20c to a positive potential +V, a negative potential −V or a neutral point potential NP, which, for example, can be provided by a DC link. For connecting the respective phase 20a, 20b, 20c to the potentials +V, −V or NP, each half bridge can include controllable semiconductor switches 22a, 22b, 22c. The power semiconductor switches 22a, 22b, 22c can include thyristors, IGCTs and/or IGBTs.

According to an exemplary embodiment of the disclosure, the converter 12 can include at least one half bridge 18a, 18b, 18c for switching an DC input voltage into an AC output voltage.

According to an exemplary embodiment of the disclosure, the converter system 12 can include at least one phase, for example, three phases 20a, 20b, 20c.

The electrical load 14 can include an electrical motor 14, for example, a medium voltage drive 14, or an electrical grid 14, which can be supplied by the converter 12.

The controller 16 of the converter 12, which is adapted for determining measurement values of the converter system 10 and for actuating the switches 22a, 22b, 22c, can include a communication (and/or measurement) unit 24, a multi-core processor 26 and a commonly shared main memory 28. The communication unit 24 and the multi-core processor 26 can read and write data into the main memory 28.

The communication unit 24 can receive measurement values from the converter 12 and/or the load 14 and can write these values into the main memory 28. Furthermore, the communication unit 24 can read a next switching state from the main memory 28 and can actuate (for example, control) the switches 22a, 22b, 22c, such that they can be switched to this switching state.

The multi-core processor 26 can read the measurement values and an actual switching state from the main memory 28 and can determine the next switching state from these data as will be explained in detail in the following.

The multi-core processor 26 has at least two processor cores 30a, 30b, 30c, 30d, for example, 4, 8 or 16 processor cores. The processor cores 30a, 30b, 30c, 30d can be equally designed. Each of the processor cores 30a, 30b, 30c, 30d can be adapted to read and write data into the main memory 28. For example, a communication between the cores can be performed via the main memory 28.

Each processor core 30a, 30b, 30c, 30d can include a cache memory 32a, 32b, 32c, 32d, which can be much smaller than the main memory 28, for example 64 kB.

The processor cores 30a, 30b, 30c, 30d and/or their respective cache 32a, 32b, 32c, 32d can be located on one chip. However, other configurations can be possible, for example, 4 independent processors on one board each having one core.

GMPDTC Method

FIG. 2 shows a flow diagram for a GMPDTC method.

GMPDTC can exploit that output values of the electrical state (for example torque, flux and/or neutral point potential) of the system 12 do not need to be kept as close as possible to their references but just within a specific band that can be limited by specific bounds. In every sampling instant, the control algorithm can verify by means of the mathematical prediction model, whether the previous calculated electrical state can be applied again without driving one (or more) of the output values outside their bands. If this is not the case, the algorithm can determine the next control move by solving an MPC problem that can use the discrete-time model of the load 14 to predict the evolution of the electrical state depending on the converter switches 22a, 22b, 22c.

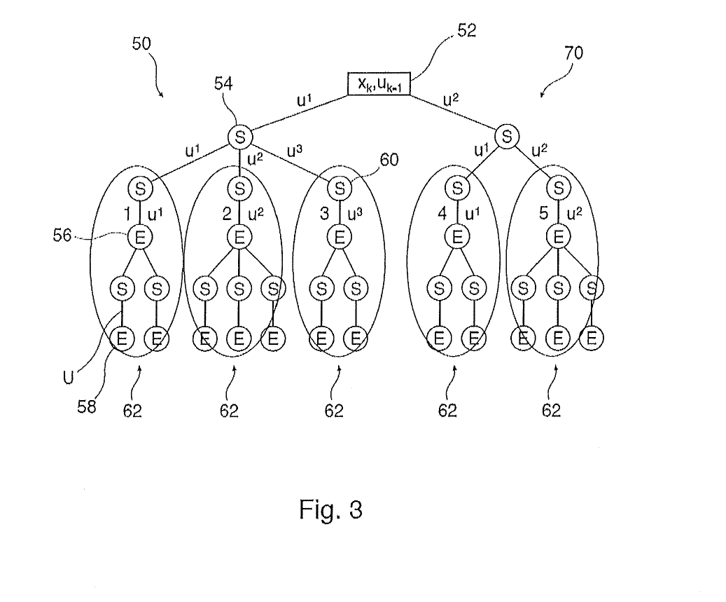

In accordance with an exemplary embodiment, to achieve a long prediction horizon (to be distinguished from the switching horizon), a control strategy can be introduced that partitions the prediction horizon into periods in which switching is allowed and periods in which the switches can be frozen until one of the predicted outputs will violate its band. The switching sequence of switching steps S and move-blocking steps (also referred to as extension steps) E, which will be explained in more detail with respect to FIG. 3, can be a parameter of the algorithm and can be used instead of a fixed prediction horizon, for example, the length of the prediction horizon varies due to the variable length of the extension steps.

With respect to FIG. 2, in step 100, the communication unit 24 can determine the actual electric state xₖ of the converter system 10.

The actual electric state xₖ can include measured currents and/or voltages in the electrical load 14 and/or in the DC link, in which the converter 12 can be connected. The actual electric state xₖ can include output values like a torque and/or a flux of the load 14 and/or a neutral point potential of the converter 10.

The actual electric state xₖ can be written to the main memory 28.

Furthermore, an actual switching state uₖ₋₁ of the converter 12 can be determined. The actual switching state of the converter 12 can include the actual switching states of the switches 22a, 22b, 22c. The actual switching state uₖ₋₁ can be the last switching state that has been applied to the converter 12 by the communication unit 24.

In accordance with an exemplary embodiment, a switching state u of the converter 12 can include switching states of the switches 22a, 22b, 22c of the converter 12 (for example whether a switch is on or off), or more general a state of the half bridge 18a, 18b, 18c (for example, whether the half bridge is connecting the phase to +V, NP or −V, which can be denoted by +1, 0, −1).

According to an exemplary embodiment of the disclosure, an actual switching state uₖ₋₁ of the electrical converter 12 can be received in the processor 16.

In step 102, a scenario tree 50 is generated (see FIG. 3).

The root node 52 can include the actual electric state xₖ and/or the actual switching state uₖ₋₁ of the converter 12.

The other nodes of the scenario tree 50 can be generated by applying a control strategy to the root node 52. The control strategy can be denoted by a sequence of characters S and E corresponding to switching and extension actions. FIG. 3 shows exemplarily the switching scenario tree 50 for the control strategy SSESE. The scenario tree 50 can be generated by iteratively attaching nodes to all intermediate leave nodes already generated by the characters of the control strategy.

For a switching action S, a switching node (for example 54) for each possible switching state that can follow the switching state of the parent node (for example 52) is attached to every intermediate leave node. The possible switching states can be all different switching states, for example 9 different switching states for a three-phase three-level inverter. For example, a 3-level 3-phase inverter can have 27 different switch configurations. Depending on the previous switching state, the number of feasible new switch configurations can be lower, for example 8 or 12.

For an extension action E, an extension node (for example 56) can be attached to every intermediate leave node.

In this way, a scenario tree 50 of switching sequences U can be generated. Each switching sequence can be defined via the nodes of the path from the root node 52 to a leave node 58. A switching sequence can be defined by a vector U=[uₖ₋₁, uₖ, . . . , u_{(k+N-1)}], wherein N is the switching horizon of the switching sequence U and by the extension times defined between specific switching states.

A scenario tree 50 generated with the control strategy SSESE for a three-phase three-level converter 12 can define at least 27 different switching sequences U. The number of different switching sequences can be equal to the number of leave nodes and can usually be much higher than 27. If one only considers the first element of these sequences, there can be 27 possibilities for a 3-level 3-phase converter.

According to an exemplary embodiment of the disclosure, a scenario tree 50 for possible future switching states of the electrical converter 12 can be determined based on the actual switching state uₖ₋₁.

According to an exemplary embodiment of the disclosure, the scenario tree 50 can define a plurality of possible future switching sequences,

According to an exemplary embodiment of the disclosure, a switching sequence U can be defined by a path from a root node 52 of the scenario tree 50 to a leave node 58 of the scenario tree 50.

In step 104, the switching sequences U can be weighted with costs or weights w. During this step, the control algorithm traverses the scenario tree 50 and calculates a weight w for each node of the tree 50. The weight w of a switching sequence U can be the weight of its associated leave node 58.

The weight w of a node can be based on the switching costs that can be calculated for each switching transitions, when switching from the switching state of the parent node to the next switching state of the node. For the calculation of the switching costs, a mathematical model of the system 10 can be used.

According to an exemplary embodiment of the disclosure, a weight w can be calculated for a switching sequence with respect to a control objective, for example, to minimize switching losses, by evaluating nodes 60 of the scenario tree 50. Different weights and/or costs can encode different control objectives. While the reduction of switching losses can be the main optimization goal in GMPDTC, a different converter application can have a different control objective, for example, keeping electrical states as close as possible to desired reference values (for example track a reference torque).

According to an exemplary embodiment of the disclosure, a weight w of a node 60 can be determined by calculating switching losses of a switching transition associated with the node 60, for example, the switching transition occurring, when switching from the switching state of the parent node to the switching state of the node itself. The weight w can also be calculated based on the state xₖ of system, for example, voltages or currents.

According to an exemplary embodiment of the disclosure, a weight of a switching sequence U can be calculated based on the weight of the node 60 and a weight of a parent node 54 of the node.

Furthermore, during step 104, for each switching sequence U the electrical state xₖ of the system 10 can be extrapolated in the future. While traversing the scenario tree 40, the control algorithm can calculate the electrical state of a node from the electrical state of its parent node.

For an S-node, the switching costs can be calculated and the electrical state can be extrapolated one sampling instance in the future.

For an E-node, the electrical state can be extrapolated in the future until bounds on the extrapolated state can be violated.

According to an exemplary embodiment of the disclosure, the scenario tree 50 can include switching nodes S and/or extension nodes E.

According to an exemplary embodiment of the disclosure, evaluating a switching node S can include calculating a weight for a switching node based on switching losses of a switching transition defined by the switching node.

According to an exemplary embodiment of the disclosure, evaluating an extension node E can include calculating an extension time for an extension nodes by extrapolating an electrical state of the converter 12 until the electrical state leaves a predefined interval.

A switching sequence U together with its extrapolated electrical state xₖ can be seen as a future scenario of the converter system 10. In such a way, every leave node 58 can be associated with a scenario. Each scenario can have a weight w making a prediction about the losses of the converter 12, when performing the scenario.

In the end, every leave node 58 of the tree 50 can be associated with a specific weight (or cost) w depending on the number of switch transitions and band violations occurred during the switching sequence U.

In step 106, from the switching sequence U with the lowest (or best) weight w, the switching state uₖ following the switching state uₖ₋₁ of the root node can be chosen as the next switching state uₖ of the converter 12 and written into the memory 28. The algorithm can choose the control law that is associated with the leave node 58 that has minimum costs and applies only the first control move uₖ to the inverter in accordance with the moving horizon policy.

According to an exemplary embodiment of the disclosure, the next switching state uₖ to be applied to the electrical converter 12 can be determined from a switching sequence with a best weight.

In step 108, the communication unit 24 reads the next switching state uₖ from the memory 28 and controls the switches 22a, 22b, 22c of the converter 12, such that the converter 12 can be switched to this switching state.

The steps 100 to 108 can be performed in each switching cycle of the converter 12.

It has to be noted that GMPDTC can be performed in different ways. For example, steps 104 and 106 can be part of step 102.

In general, GMPDTC can apply a special move-blocking strategy to achieve long prediction horizons at a reduced number of switching scenarios. In accordance with an exemplary embodiment, this can be advantageous for applications in which calculation time is very limited (such as in DTC) because in a standard MPC problem formulation the number of switching sequences U to be considered would grow exponentially with the prediction horizon and would therefore limit the method to very short horizons.

In the following, exemplary embodiments can be given, how the GMPDTC algorithm can be executed on multiply processor cores 30a, 30b, 30c, 30d.

According to an exemplary embodiment of the disclosure, the evaluation of the nodes 60 can be performed by at least two processor cores 30a, 30b, 30c, 30d.

GMPDTC can be seen as a tree traversal problem in which each node 60 (note that the reference numeral 60 can be used for a general tree node) of the scenario tree 50 is visited exactly once. Already sequential implementations can have execution times that depend significantly on data layout and code organization. For a parallel implementation, these effects can be expected to be amplified. For example, the order in which the nodes 60 can be visited (for example, depth-first or bread-first) can play an important role. An efficient parallelization strategy can depend strongly on the time needed to compute a single node 60, the time spent for communication of the relevant node data between the processor cores 30a, 30b, 30c, 30d and/or the number of processor cores 30a, 30b, 30c, 30d. An efficient parallelization of GMPDTC can have to consider not only the time spent on node evaluation and inter-core communication but can also have to employ efficient data structures and take architecture dependent characteristics such as memory cache size 32a, 32b, 32c, 32d into account.

For example, if communication is expensive in contrast to evaluating the nodes 60, a solution can be to split the tree 50 into several sub-trees 62, which can be then computed in parallel on different processor cores 30a, 30b, 30c, 30d.

During the exploration of the scenario tree 50, GMPDTC can prune tree branches corresponding to switching sequences U that would result in outputs with increasing band violation. In the case that no feasible switching scenario is left after the pruning, the algorithm can employ an infeasible-exit strategy for selecting the next switching command to guarantee fail-safe operation.

Centralized Node Pool Management

An exemplary example of parallel execution can be centralized node pool management during the steps 102 to 106.

If the inter-core communication between the cores 30a, 30b, 30c, 30d can be relatively inexpensive in comparison to the time needed to compute a node 60, a centralized pool of pending tree nodes 60 can be used, which can be then distributed by a master process to the various cores.

For example, in step 102, a master process, that, for example, is executed by the processor core 30a, generates the tree 50 and, for example, the tree nodes 60 of the tree 50. The tree nodes 60 can be stored in a centralized node pool in the main memory 28.

According to an exemplary embodiment of the disclosure, a central node pool of nodes 60 of the scenario tree 50 that have to be evaluated can be generated, for example, in the main memory.

In step 104, the master process distributes pending tree nodes 60 to slave processes, that, for example can be executed in the other processor cores 30b, 30c, 30d.

According to an exemplary embodiment of the disclosure, the nodes 60 of the central node pool can be distributed to the processor cores 30a, 30b, 30c, 30d.

The slave processes then perform the necessary operations on the received pending tree nodes 60 and return the results back to the master process, which can maintain global knowledge.

According to an exemplary embodiment of the disclosure, the nodes 60 distributed to a processor core can be evaluated at the processor core.

A breadth-first approach for selecting the next pending nodes from the pool can be used. In accordance with an exemplary embodiment, this can be advantageous because it can quickly produce a huge number of nodes preventing starvation of processor cores. However, the storage needed for the centralized node pool can be significantly higher than with a depth-first strategy.

In step 106, the master process can select the switching sequence with the lowest weight.

Distributed Node Pool Management

An exemplary example of parallel execution can be distributed node pool management during the steps 102 to 106.

If inter-core communication between the cores 30a, 30b, 30c, 30d is expensive in contrast to node evaluation, a distributed node pool management can be used.

For example, in step 102, a master process, that, for example, can be executed by the processor core 30a, generates only the first level(s) of the scenario tree 50. Each branch of this incomplete scenario tree can be distributed to a parallel process, that, for example, can be executed in the processor cores 30a, 30b, 30c, 20d.

In step 104, every slave process can be working on a subset of pending tree nodes 60 it stores in its own local node pool, for example in its local memory cache 32a, 32b, 32c, 32d.

According to an exemplary embodiment of the disclosure, at least two local node pools of nodes 60 of the scenario tree 50 can be generated with at least two processor cores 30a, 30b, 30c, 30d.

According to an exemplary embodiment of the disclosure, nodes 60 of a local node pool can be evaluated with a processor core that has generated the respective local node pool.

In accordance with an exemplary embodiment, to avoid uneven workloads, a load balancing strategy can be used, which can take over the redistribution of pending nodes 60 and updating the global variables (for example, value of the incumbent node). In accordance with an exemplary embodiment, the load balancing can be performed by the master process.

In step 106, the master process can select the switching sequence with the lowest weight.

Although the distributed node pool strategy can use less communication than the centralized approach, even modest inter-core communication can deteriorate overall performance significantly for applications that use cycle times in the microsecond range.

Splitting into Sub-Trees

In accordance with an exemplary embodiment, an example of parallel execution can be splitting into sub-trees or sub-paths during the steps 102 to 106. Splitting the global scenario tree 50 into sub-trees 62 which can be then assigned to the cores for parallel computation can be considered as a special variant of the distributed node pool management described above.

In step 102, the scenario tree 50 can be generated and split into sub-trees 62.

For example, a master process that, for example, is executed by the processor core 30a, can generate the tree 50 in main memory 28 and can split it into sub-trees 62 according to a general rule. However, it is not necessary that the master process generate the full tree in the main memory 28 as the slave processes can generate their individual sub-trees on the fly (in their local cache memory 32a, 32b, 32c, 32d).

For example, the global scenario tree 50 can be split at the nodes 54 of the first level. For example, the sub-trees 62 can have root nodes 54 that can be the first level nodes of the global scenario tree 50. The sub-trees 62 can be then distributed to the processor cores 30a, 30b, 30c, 30d. For example, each sub-trees 62 can be stored in the respective local cache memory 32a, 32b, 32c, 32d.

In accordance with an exemplary embodiment, parallel processes can be executed in the processor cores 30a, 30b, 30c, 30d can generate the tree 50 in its local cache memory 32a, 32b, 32c, 32d, for example, after reading the inputs xₖ and uₖ₋₁. In accordance with an exemplary embodiment, the parallel processes can only generate the small sub-trees they can be interested in, for example, only a part of the full tree 50.

After that, the parallel process can split the scenario tree 50 themselves. In this case, no master process is needed.

Depending on the number of processor cores offered by the controller 16, the scenario tree 50 can be split at different levels to obtain sufficiently many sub trees 62 to keep all processor cores 30a, 30b, 30c, 30d busy.

The approach of splitting into (real) sub-trees 62 can be used if only few processor cores can be available and inter-core communication should be kept at a minimum level.

According to an exemplary embodiment of the disclosure, the scenario tree 50 can be split into sub-trees 62 and the sub-trees 62 can be distributed to at least two processor cores 30a, 30b, 30c, 30d.

According to an exemplary embodiment of the disclosure, a weight for a switching sequence of a first sub-tree 62 can be calculated with a first processor core 30a and a weight for a switching sequence of a second sub-tree 62 can be calculated with a second processor core 30b.

In accordance with an exemplary embodiment, in the case that the controller 16 offers as many processor cores as there can be leave nodes 58 in the scenario tree 50, every processor core 30a, 30b, 30c, 30d can compute only one scenario. The individual paths (switching sequences) can be computed by the processor cores 30a, 30b, 30c, 30d accepting the redundancy of computations performed at the upper tree levels. An efficient implementation of this strategy can include a quick aggregation of scenario results. For example, specific processor cores can execute master processes that determine the scenario with the lowest weight for a group of processor cores. The approach can be suited for execution on GPU architectures, which can be specialized on executing the same instruction on multiple data.

According to an exemplary embodiment of the disclosure, the scenario tree 50 can be split into single switching sequences U and the switching sequences U can be distributed to a plurality of processor cores 30a, 30b, 30c, 30d.

According to an embodiment of the disclosure, a weight for a switching sequence U can be calculated with a processor core, in which the switching sequence U has been distributed to.

The number of sub-trees 62 into which the global scenario tree 50 is split can be a design parameter and can be chosen depending on the number of available processor cores 30a, 30b, 30c, 30d. A solution can be to partition the global scenario tree 50 at the first level into sub-trees 62 whose root nodes 54 can be the first level nodes 54 of the global tree 50.

Due to the switching constraints imposed by the hardware (for example, the switches 22a, 22b, 22c) of the converter 12, the sub-trees 62 can have different size. Therefore, the time it takes to explore a specific sub-tree 62 can be different as well.

For each actual switching state uₖ₋₁, a lookup table 70 can be stored in the controller 16 that has been pre-calculated for a specific control strategy (for example, SSESE).

Each lookup table 70 can include the scenario tree 50 for a specific switching state uₖ₋₁. The lookup tables 70 can be stored in the global memory 28 or in each cache memory 32a, 32b, 32c, 32d.

Furthermore, the lookup table 70 can include information into which sub-trees 62 the global scenario tree 50 should be split and/or an estimated processing time of the respective sub-tree 62 (see FIG. 3).

For example, in the case of the scenario tree 50 of FIG. 3, the lookup table 70 can include the sub-trees 62 and the following (fictitious) table including the estimated times needed to process a sub-tree 62:

| Sub tree: | Time: |
|---|---|
| 1, 3, 4 | 3 |
| 2, 5 | 5 |

From these execution times, a scheduling strategy can be derived, for example, which processor cores 30a, 30b, 30c, 30d should process which sub-tree 62 and in which order.

Also the scheduling strategy can be stored in the look-up table 70. The scheduling strategy for a switching cycle can then be selected depending on the previously applied switching state uₖ₋₁. The lookup table 70 can store which processor core 30a, 30b, 30c, 30d can process which sub-tree 62 and/or can store the order of the processing of the sub-trees 62 by one processor core 30a, 30b, 30c, 30d.

A resulting distribution of the sub-trees using an LPT rule for a controller 16 with two processor cores 30a, 30b is shown below:

| CPU core: | Sub tree: |
|---|---|
| 1 | 2, 1, 4 |
| 2 | 5, 3 |

Note that because in this example the splitting can be performed at the second level of the scenario tree 50, the resulting schedule can involve redundant computations for the nodes 52, 54 at the first level.

In accordance with an exemplary embodiment, the scheduling strategy can be pre-calculated and stored in the controller 16. However, if the control algorithm is able to provide additional information about the scenario tree 50 structure at runtime, an online scheduling based on a heuristic such as LPT (see below) can be used for scheduling. In accordance with an exemplary embodiment, to meet the real time uses, the heuristic should have a low computational demand. If a computational inexpensive scheduling heuristic is used, the schedules can be computed and updated in every switching cycle to take additional information from the control algorithm into account, which can be only available online.

According to an exemplary embodiment of the disclosure, the scenario tree 50 can be determined by loading at least parts of the scenario tree 50 from a pre-calculated table 70.

According to an exemplary embodiment of the disclosure, a splitting into sub-trees 62 of the scenario tree 50 can be predefined in the table 70.

According to an exemplary embodiment of the disclosure, a calculation/processing time of a sub-tree 62 of the scenario tree 50 can be predefined in the table 70. The calculation and/or processing time of a sub-tree does not need to be stored in the table. For example, the table only needs to pre-calculate the distribution of the sub-trees to the processor cores.

According to an exemplary embodiment of the disclosure, a distribution of sub-trees 62 to processor cores 30a, 30b, 30c, 30d can be predefined in the table 70.

In step 104, the processor cores 32a, 32b, 32c, 32d can calculate the scenarios associated with the sub-trees 62. The resulting weight w for each switching sequence/scenario can be stored in the local cache memory 32a, 32b, 32c, 32d.

In step 106, the scenario with the lowest weight can be determined.

For example, all parallel processes write at least the next possible switching states uₖ and their weights w to the main memory 28. After that, a master process can determine the switching state with the lowest weight w.

In accordance with an exemplary embodiment, each processor core 30a, 30b, 30c, 30d can select its local lowest weight w and writes this local best weight w and at least the corresponding next possible switching state uₖ to the main memory 28. After that, a master process can determine the global lowest weight from the local lowest weights.

In accordance with an exemplary embodiment, it can be noted that for accelerating the processing, the code of the master process and of the parallel/slave processes can be stored in the respective cache memory 32a, 32b, 32c, 32d of the processor core 30a, 30b, 30c, 30d that executes the respective process.

Scheduling Strategy

In accordance with an exemplary, the following scheduling strategies can be used online or for calculating the lookup table 70 can be explained.

The problem of optimally distributing the individual sub-tree exploration problems to the available processor cores 30a, 30b, 30c, 30d can be posed as a makespan minimization problem, a problem in scheduling theory: given m machines (the cores 30a, 30b, 30c, 30d) and n jobs (the sub-trees 62) with known processing times p₁, . . . , pₙ, the makespan minimization problem is to find a scheduling strategy that finishes the batch of jobs in minimum time.

Under the assumption that processing of a job must not be interrupted and each job can be processed on any machine, the minimum makespan is known to be NP-hard already for m=2 machines. For example, an optimal schedule can be given by the solution of the following integer linear problem (ILP):

$${C}_{max} ( OPT ) := min {C}_{max}$$

$$\begin{matrix}subject to & {\sum }_{j = 1}^{n} {x}_{ij} {p}_{j} \leq {C}_{max} , & i = 1 , … , m \\ & {\sum }_{i = 1}^{m} {x}_{ij} = 1 , & j = 1 , … , n \\ & {x}_{ij} = \{ 0 , 1 \} , & i = 1 , … , m , j = 1 , … , n\end{matrix}$$

A heuristic achieving approximate solutions for the makespan minimization problem is the Longest Processing Time first (LPT) rule. At the begin of the schedule the LPT-rule assigns the longest m jobs to the m machines. After a machine has finished a job, the job with the longest processing time from the remaining jobs will be assigned to it.

The optimal schedule (or at least a good schedule) can be calculated by solving the above mentioned IPL (or LPT):

The structure of each scenario tree 50 imposed by the converter switching restrictions can be known.

An upper bound of the computations involved with each node 60 can be estimated a-priori, because the mathematical model of the system 10 that is used during step 104 and/or the corresponding algorithm for evaluating step 104 is known. Thus, an upper bound for the calculation (or number of instructions to be executed) can be known. In an exemplary case, a fixed value can be used for S-nodes and E-nodes.

The processing times of the sub-trees 62 can then be estimated for a worst-case scenario. This can allow applying existing results from scheduling theory to efficiently parallelize MPDTC: the processing of the sub-trees 62 can be distributed either optimally by solving the associated ILP, by using the LPT-rule or similar rules as a scheduling heuristic. Simulation results have shown that for GMPDTC of reasonable control horizons, the LPT rule can deliver near to optimal schedules.

While the disclosure has been illustrated and described in detail in the drawings and foregoing description, such illustration and description can be to be considered illustrative or exemplary and not restrictive; the disclosure is not limited to the disclosed embodiments. Other variations to the disclosed embodiments can be understood and effected by those skilled in the art and practising the claimed disclosure, from a study of the drawings, the disclosure, and the appended claims. In the claims, the word “comprising” does not exclude other elements or steps, and the indefinite article “a” or “an” does not exclude a plurality. A single processor or controller or other unit can fulfil the functions of several items recited in the claims. The mere fact that certain measures can be recited in mutually different dependent claims does not indicate that a combination of these measures cannot be used to advantage. Any reference signs in the claims should not be construed as limiting the scope.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. A method for controlling an electrical converter, the method comprising:
receiving an actual switching state (uₖ₋₁) of the electrical converter;
determining a scenario tree for future switching states of the electrical converter based on the actual switching state (uₖ₋₁), the scenario tree defining a plurality of future switching sequences, a switching sequence (U) being defined by a path from a root node of the scenario tree to a leave node of the scenario tree;
calculating a weight (w) for a switching sequence with respect to a control objective of the electrical converter by evaluating nodes of the scenario tree;
determining the next switching state (uₖ) to be applied to the electrical converter from a switching sequence with a best weight;
performing the evaluation of the nodes by at least two processor cores; and
determining the scenario tree by loading at least parts of the scenario tree from a pre-calculated table, wherein a calculation time of a sub-tree of the scenario tree is predefined in the table.

2. The method of claim 1, comprising:
splitting the scenario tree into sub-trees; and
distributing the sub-trees to the at least two processor cores.

3. The method of claim 2, comprising:
calculating a weight for a switching sequence of a first sub-tree with a first processor core; and
calculating a weight for a switching sequence of a second sub-tree with a second processor core.

4. The method of claim 1, comprising:
splitting the scenario tree into switching sequences (U);
distributing the switching sequences (U) to a plurality of processor cores; and
calculating a weight for a switching sequence with a processor core to which the switching sequence has been distributed.

5. The method of claim 1, comprising:
determining a weight (w) of a node by calculating switching losses of a switching transition associated with the node; and
calculating a weight of a switching sequence (U) based on the weight of the node and a weight of a parent node of the node.

6. The method of claim 1, comprising:
generating a central node pool of nodes of the scenario tree to be evaluated;
distributing a node of the central node pool to a processor core; and
evaluating the node at the processor core.

7. The method of claim 1, comprising:
generating at least two local node pools of nodes of the scenario tree with at least two processor cores; and
evaluating nodes of a local node pool with a processor core that has generated the local node pool.

8. The method of claim 1, comprising:
predefining in the table a splitting into sub-trees of the scenario tree; and/or
predefining in the table a distribution of sub-trees to processor cores.

9. The method of claim 1, wherein the scenario tree includes switching nodes (S).

10. The method of claim 9, comprising:
evaluating a switching node (S) by calculating a weight for a switching node based on switching losses of a switching transition defined by the switching node.

11. The method of claim 1, wherein the scenario tree includes extension nodes (E), and evaluating an extension node (E) comprises:
calculating an extension time for the extension nodes by extrapolating an electrical state of the converter until the electrical state leaves a predefined interval.

12. A method for controlling an electrical converter, the method comprising:
receiving an actual switching state (uₖ₋₁) of the electrical converter;
determining a scenario tree for future switching states of the electrical converter based on the actual switching state (uₖ₋₁), the scenario tree defining a plurality of future switching sequences, a switching sequence (U) being defined by a path from a root node of the scenario tree to a leave node of the scenario tree;
calculating a weight (w) for a switching sequence with respect to a control objective of the electrical converter by evaluating nodes of the scenario tree;
determining the next switching state (uₖ) to be applied to the electrical converter from a switching sequence with a best weight;
performing the evaluation of the nodes by at least two processor cores; and
determining the scenario tree by loading at least parts of the scenario tree from a pre-calculated table, wherein a calculation time of a sub-tree of the scenario tree is predefined in the table.

13. A non-transitory computer readable medium having a computer program recorded thereon that, when executed by at least two processor cores, causes the at least two processor cores to carry out a method for controlling an electrical converter, the method comprising:
receiving an actual switching state (uₖ₋₁) of the electrical converter;
determining a scenario tree for future switching states of the electrical converter based on the actual switching state (uₖ₋₁), the scenario tree defining a plurality of future switching sequences, a switching sequence (U) being defined by a path from a root node of the scenario tree to a leave node of the scenario tree;
calculating a weight (w) for a switching sequence with respect to a control objective of the electrical converter by evaluating nodes of the scenario tree;
determining the next switching state (uₖ) to be applied to the electrical converter from a switching sequence with a best weight;
performing the evaluation of the nodes by the at least two processor cores; and
determining the scenario tree by loading at least parts of the scenario tree from a pre-calculated table, wherein a calculation time of a sub-tree of the scenario tree is predefined in the table.

14. The computer program of claim 13, comprising:
splitting the scenario tree into sub-trees; and
distributing the sub-trees to the at least two processor cores.

15. The computer program of claim 14, comprising:
calculating a weight for a switching sequence of a first sub-tree with a first processor core; and
calculating a weight for a switching sequence of a second sub-tree with a second processor core.

16. A controller for an electrical converter, the controller comprising:
a multi-core processor including at least two processor cores; and
wherein the multi-core processor is configured to:
receive an actual switching state (uₖ₋₁) of an electrical converter;
determine a scenario tree for future switching states of an electrical converter based on the actual switching state (uₖ₋₁), the scenario tree defining a plurality of future switching sequences, a switching sequence (U) being defined by a path from a root node of the scenario tree to a leave node of the scenario tree;
calculate a weight (w) for a switching sequence with respect to a control objective of an electrical converter by evaluating nodes of the scenario tree;
determine the next switching state (uₖ) to be applied to an electrical converter from a switching sequence with a best weight;
perform the evaluation of the nodes by the at least two processor cores; and
determine the scenario tree by loading at least parts of the scenario tree from a pre-calculated table, wherein a calculation time of a sub-tree of the scenario tree is predefined in the table.

17. The controller of claim 16, comprising:
splitting the scenario tree into sub-trees; and
distributing the sub-trees to the at least two processor cores.

18. The controller of claim 17, comprising:
calculating a weight for a switching sequence of a first sub-tree with a first processor core; and
calculating a weight for a switching sequence of a second sub-tree with a second processor core.

19. A converter system, comprising:
an electrical converter for generating a variable AC output current; and
a controller according to claim 15 for switching semiconductor switches of the electrical converter.

20. The controller of claim 19, comprising:
splitting the scenario tree into sub-trees; and
distributing the sub-trees to the at least two processor cores.

21. The controller of claim 20, comprising:
calculating a weight for a switching sequence of a first sub-tree with a first processor core; and
calculating a weight for a switching sequence of a second sub-tree with a second processor core.
